(19) United States
(12) Patent Application Publication
(10) Pub. No.: US 2007/0198381 A1
(43) Pub. Date: Aug. 23, 2007

(54) Charitable gift program

(76) Inventor: Chad Ettmueller, Cumming, GA (US)

Correspondence Address: ARNOLD & PORTER LLP;ATTN: IP DOCKETING DEPT., 555 TWELFTH STREET, N.W., WASHINGTON, DC, 20004-1206, US

(21) Appl. No.: 11/657,543

(22) Filed: Jan. 25, 2007

Related U.S. Application Data
(60) Provisional application No. 60/762,510, filed on Jan. 27, 2006.

(51) Int. Cl. G06Q 40/00

(52) U.S. Cl. 705/35

(57) ABSTRACT

The present invention relates to methods of implementing charitable gift programs.

### CROSS REFERENCE TO RELATED APPLICATIONS

This application claims priority under 35 U.S.C. §119(e) of provisional U.S. Application Ser. No. 60/762,510, filed Jan. 27, 2006, the entirety of which is herein incorporated by reference.

### TECHNICAL FIELD

The present invention relates to methods of implementing charitable gift programs.

### BACKGROUND

In a typical charitable gift annuity (“CGA”) program, an individual makes a payment to a charity in exchange for a commitment by the charity to pay a fixed annuity amount periodically to the donor or another person designated by the donor for the life of that person or on the lives of two annuitants until the survivor's death. The charity then places the funds with a financial institution, which combines them with funds from other charities in an investment pool. The charity pays significant periodic fees to the financial institution for investment or asset management services. The charity's share of the earnings in the investment pool are paid or credited to the charity. The charity uses these or other funds to make the annuity payments to the designated annuitant(s). When the annuity obligation terminates (upon the death of the last annuitant), the charity may withdraw the remaining funds attributable to that CGA from the investment pool and use them for other purposes.

From the perspective of many charities, particularly small to mid-size charities, there are at least three problems that make this typical CGA program unattractive as a source of charitable giving to fund the charity's programs. First, the charity cannot use the funds received from the donor immediately for charitable purposes. Second, there is no assurance that the return on the investment of these funds will equal or exceed the annuity rate owed to the annuitant(s). If there is a shortfall, the charity must use its other assets to make up the difference. Third, the charity must pay very substantial periodic (i.e., monthly, quarterly or annual) asset management or investment fees while the funds are maintained in the investment pool.

What is needed, therefore are charitable gift annuity programs that overcome these problems.

### SUMMARY OF THE PREFERRED EMBODIMENTS

In one exemplary embodiment, the present invention provides a method of implementing a charitable gift annuity program. The method includes the acts of receiving property from a donor, providing a contract for payment of annuities to a recipient, wherein the annuity is less than the value of the property received; and providing a charitable gift annuity to a donor, wherein the charitable gift annuity is based on the life or lives of one or more individuals, living at the time the annuity is issued.

In accordance with a preferred embodiment, the value of the annuity is less than 90 percent of the value of the property received.

### BRIEF DESCRIPTION OF THE DRAWINGS

FIG. 1 shows entities involved with a charitable gift annuity program in accordance with one embodiment of the present invention.

### DETAILED DESCRIPTION

The present invention relates to a charitable gift program, and more particularly to a charitable gift annuity (“CGA”) program that addresses these problems. In one embodiment, the present invention provides a CGA program that may, for example, be made available to charities by a “broker”, a major, highly-rated life insurance company (the “insurer”), or another party. In one embodiment, appropriate licenses for the sale of annuities are obtained prior to the sale of a CGA of the present invention. In a preferred embodiment, a broker obtains the appropriate licenses for the sale of annuities and will be appointed to represent the insurer under the appropriate states' insurance laws. In another preferred embodiment, the insurer will take all necessary actions to conduct an insurance business, including the issuance of annuity contracts, under the appropriate states' insurance laws.

The following is a detailed description of a preferred CGA program:

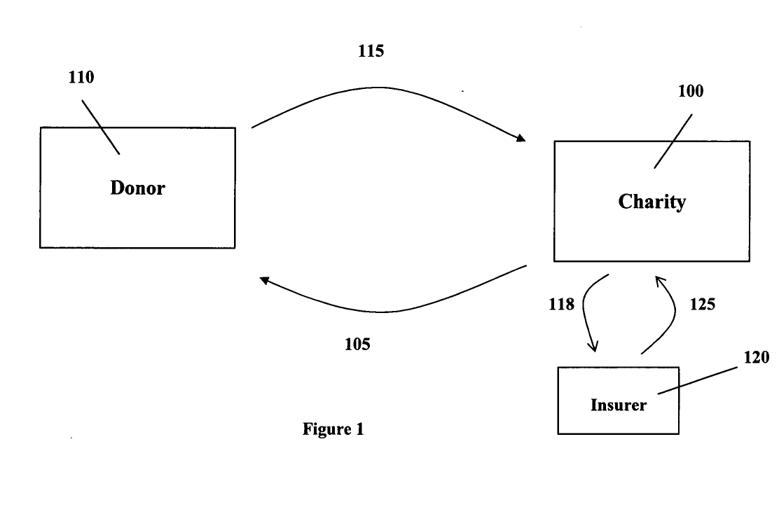

As shown in FIG. 1, in one embodiment, a charitable organization (the “charity”) 100 will offer 105 a charitable gift annuity to an individual (“donor”) 110, based on the life or lives of one or more, preferably one or two, individuals in being (the “annuitant”) at the time the annuity is issued (“CGA contract”). The CGA contract will preferably be the sole consideration issued in exchange for the transfer 115 of cash or property by a donor 110 to the charity 100. The value of the CGA contract will preferably be less than the amount of cash or the value of other property transferred by the donor 110 to the charity 100. More preferably, the CGA contract will be less than ninety percent of the amount of cash and/or the value of other property transferred by donor to the charity.

The CGA contract will preferably specify the amount of each periodic payment but, preferably, will not guarantee a minimum number, specify a maximum number, or will not both guarantee a minimum number and specify a maximum number of periodic payments to the annuitant. Preferably the CGA contract also will not specify a minimum and/or maximum aggregate amount of payments to be received by the annuitant and will not provide for any adjustment of the amount of the annuity payments by reference to the income received from the property transferred by donor to the charity or any other property.

The CGA contract will preferably provide that each periodic annuity payment is payable from the charity's general assets; however, the donor and annuitant will preferably be aware that the charity will purchase an annuity from an insurer to at least match its liability associated with the CGA contract.

The charity 100 will preferably purchase 118 an annuity policy from an insurer 120, who will provide 125 the annuity policy (“commercial annuity”), based on the annuitant's life and with the same periodic payment amount and frequency as specified in the CGA contract. Where necessary to comply with relevant laws, for example state insurable interest laws, the annuitant will preferably expressly grant the charity the necessary authorization to purchase an annuity from insurer with the annuitant's life being used as the measuring life. Preferably, the commercial annuity will be purchased with a single premium and a payout starting date commencing no later than one year from the date of the purchase of the commercial annuity. The commercial annuity will preferably pay to the charity periodic payments (preferably a series of substantially equal payments to be made not less frequently than annually), which will match the charity's obligation to the annuitant, during the CGA contract payout period. As explained more fully below, the charity may preferably receive an additional payment upon the death of the annuitant.

The payment made by the donor as consideration for the CGA contract will preferably exceed the insurer's market rates for a commercial annuity with the same payout period and periodic payment amount. The difference between the amount paid by the donor for the CGA Contract and the premium paid by the charity to the insurer for the commercial annuity can be retained by the charity for its immediate, unrestricted use.

In one embodiment, the broker may receive a commission from insurer for sale of the commercial annuity to the charity, and does not receive compensation from the charity for the donor's entering into the CGA contract. Further, because the charity preferably funds the CGA Contract liability through the purchase of the commercial annuity, it may not be required to pay periodic asset or investment management fees to the broker, insurer or any other party.

In one embodiment, at the charity's option and for additional consideration paid to the insurer, the commercial annuity may provide that the charity receive a guaranteed lump sum cash refund equal to the premium paid to insurer by the charity minus the periodic payments paid to the charity if annuitant dies before the total annuity payments equal or exceed the original premium payment. This refund feature will preferably not affect the charity's obligation under the CGA contract.

In another embodiment, for its administrative convenience and solely at its discretion and on its own behalf, the charity may elect to direct the insurer to make the periodic payments generated by the commercial annuity directly to annuitants to fulfill the charity's obligation under the CGA contract. However, preferably, the charity may not be required to elect this action as a condition of the CGA contract with donor.

Although different embodiments of the present invention have been discussed, those skilled in the art will appreciate that variations may be made thereto without departing from the principles of the present invention. In addition, although the preferred embodiment has been described to include a number of features, a method may be developed which does not include all of those features, and yet still falls within the spirit and scope of the present invention.

What is claimed is:

1. A method of implementing a charitable gift annuity program, comprising the acts of:
receiving property from a donor;
providing a contract for payment of annuities to a recipient, wherein said annuity has a first value that is less than a second value of the property received; and
providing a charitable gift annuity to a donor, wherein said charitable gift annuity is based on a life or lives of one or more individuals, living at the time the annuity is issued.

2. The method of claim 1, wherein said charitable gift annuity is provided by a broker.

3. The method of claim 1, wherein said charitable gift annuity is provided by a life insurance company.

4. The method of claim 1, wherein said charitable gift annuity is provided by a charitable organization.

5. The method of claim 1, wherein said annuity is the sole consideration provided for said property.

6. The method of claim 1, wherein the first value of said annuity is less than ninety percent of the second value of the property transferred.

7. The method of claim 1, wherein said annuity comprises periodic payments to a recipient.

8. The method of claim 7, wherein said contract specifies an amount to be paid in each of said periodic payments.

9. The method of claim 7, wherein said periodic payments are payable from a charitable organization's general assets.

10. The method of claim 1, wherein said recipient is an annuitant.

11. The method of claim 1, wherein said recipient is a donor.

12. A method for implementing a charitable gift annuity program, comprising the acts of:
receiving property from a donor;
providing a contract for the payment of annuities to a recipient, wherein said annuity has a first value that is less than ninety percent of a second value of the property received; and
providing a charitable gift annuity to an individual, wherein said charitable gift annuity is based on a life or lives of one or more living individuals.

13. The method of claim 12, wherein said charitable gift annuity is provided by a broker.

14. The method of claim 12, wherein said charitable gift annuity is provided by a life insurance company.

15. The method of claim 12, wherein said charitable gift annuity is provided by a charitable organization.

16. The method of claim 12, wherein said annuity is the sole consideration provided for said property.

17. The method of claim 12, wherein said annuity comprises periodic payments to an annuitant.

18. A method of implementing a charitable gift annuity program, comprising the acts of:
receiving property from a donor;
providing a contract for one or more future payments to a recipient, wherein a first value of said one or more future payments is less than a second value of the property received; and
providing one or more future payments to a donor, wherein said charitable gift payment is based on a life or lives of one or more living individuals.

19. The method of claim 18, wherein said future payment is an annuity.

20. The method of claim 18, wherein said charitable gift annuity is provided by a broker.

21. The method of claim 18, wherein said charitable gift annuity is provided by a life insurance company.

22. The method of claim 18, wherein said charitable gift annuity is provided by a charitable organization.

23. The method of claim 18, wherein said payments are the sole consideration provided for said property.

24. The method of claim 18, wherein said contract provides for periodic payments to a recipient.

25. The method of claim 24, wherein said contract specifies an amount to be paid in each of said periodic payments.

26. The method of claim 24, wherein said periodic payments are payable from a charitable organization's general assets.

27. The method of claim 18, wherein said recipient is an annuitant.

28. The method of claim 18, wherein said recipient is a donor.
